(19) United States
(12) Patent Application Publication
(10) Pub. No.: US 2025/0391882 A1
(43) Pub. Date: Dec. 25, 2025

(54) ALL-SOLID-STATE METAL BATTERY

(71) Applicant: SAMSUNG SDI CO., LTD., Yongin-si, Gyeonggi-do (KR)

(72) Inventors: Jinhoon YANG, Yongin-si, Gyeonggi-do (KR); Jungho LEE, Yongin-si, Gyeonggi-do (KR); Juhee SOHN, Yongin-si, Gyeonggi-do (KR); Hyuksoo SHIN, Yongin-si, Gyeonggi-do (KR); Sungwon JUNG, Yongin-si, Gyeonggi-do (KR)

(73) Assignee: SAMSUNG SDI CO., LTD., Yongin-si, Gyeonggi-do (KR)

(21) Appl. No.: 18/879,696

(22) PCT Filed: Nov. 3, 2023
(86) PCT No.: PCT/KR2023/017517

§ 371 Date: Dec. 27, 2024

(30) Foreign Application Priority Data
Nov. 10, 2022 (KR) 10-2022-0149951

(51) Int. Cl. H01M 4/66; H01M 4/02

(52) U.S. Cl. CPC H01M 4/667; H01M 4/661; H01M 4/663; H01M 2004/021; H01M 2004/027

(57) ABSTRACT

The present invention relates to an all-solid-state metal battery, the all-solid-state metal battery comprising a current collector, and a negative electrode which is located on one surface of the current collector and includes a negative electrode coating layer containing metal, amorphous carbon, and lithium titanium oxide particles.

### TECHNICAL FIELD

An all-solid-state metal battery is disclosed.

### BACKGROUND ART

Recently, the rapid supplement of electronic devices such as mobile phones, laptop computers, and electric vehicles, using batteries require surprising increases in demands for rechargeable batteries with relatively high capacity and lighter weight. Particularly, a rechargeable lithium battery has recently drawn attention as a driving power source for portable devices, as it has lighter weight and high energy density. Accordingly, research and development to improve the performance of rechargeable lithium batteries is being actively conducted.

An all-solid-state metal battery among rechargeable lithium batteries refers to a battery in which all materials are solid, and in particular, a battery using a solid electrolyte. One way to increase the energy density of these all-solid-state batteries is to use lithium metal as a negative electrode. However, in this case, there are problems due to lithium volume expansion and irreversible dendrite growth during charge and discharge.

To solve these problems, a method of configuring the negative electrode by forming a layer in which lithium is deposited on the negative electrode current collector during charging and discharging, without using lithium metal itself, is being studied, however, this method is not suitable because it causes low power characteristics and excessive occurrence of short-circuit phenomena.

### DETAILED DESCRIPTION OF THE INVENTION

### Technical Problem

An embodiment provides an all-solid-state metal battery exhibiting excellent electrochemical properties.

### Technical Solution

An embodiment provides an all-solid-state metal battery including a negative electrode including a current collector and a negative electrode coating layer located on one surface of the current collector and including a metal, amorphous carbon, and lithium titanium oxide particles. The lithium titanium oxide particles may be represented by Chemical Formula 1.

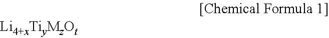

(In Chemical Formula 1, 0<x≤5, 1≤y≤5, 0≤z≤3, 3≤t≤12, and M is an element selected from Mg, La, Tb, Gd, Ce, Pr, Nd, Sm, Ba, Sr, Ca, or a combination thereof)

Another embodiment provides an all-solid-state metal battery including a negative electrode including a current collector, a negative electrode coating layer including a metal, amorphous carbon, and lithium titanium oxide particles; and a lithium deposition layer between the current collector and the negative electrode coating layer. The lithium titanium oxide particles may be a mixture of first compound particles represented by Chemical Formula 2 and second compound particles represented by Chemical Formula 3.

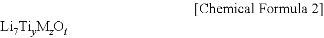

(In Chemical Formula 2, 1≤y≤5, 0≤z≤3, 3≤t≤12, and M is an element selected from Mg, La, Tb, Gd, Ce, Pr, Nd, Sm, Ba, Sr, Ca, or a combination thereof)

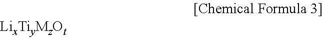

(In Chemical Formula 3, 8≤x≤9, 1≤y≤5, 0≤z≤3, 3≤t≤12, and M is an element selected from Mg, La, Tb, Gd, Ce, Pr, Nd, Sm, Ba, Sr, Ca, or a combination thereof)

A mixing ratio of the first compound particles and the second compound particles may be a weight ratio of 5:95 to 95:5.

A particle size of the lithium titanium oxide particles may be 0.1 μm to 3 μm.

A BET specific surface area of the lithium titanium oxide particles may be 1 m²/g to 20 m²/g.

A thickness of the negative electrode coating layer may be 1 μm to 15 μm.

3 to 100 of the lithium titanium oxide particles included in the negative electrode coating layer may be located in a vertical direction with respect to one surface of the current collector.

An amount of the lithium titanium oxide particles may be 1 wt % to 30 wt % based on 100 wt % of the total of the metal, the amorphous carbon, and the lithium titanium oxide particles.

In an embodiment, a particle size of the lithium titanium oxide particles may be 0.1 μm to 3 μm, and a thickness of the negative electrode coating layer may be 1 μm to 15 μm.

The all-solid-state metal battery may have a peak at 0 V to 0.4 V in a differential capacity analysis (dQ/dV) graph.

A mixing ratio of the first compound particles and the second compound particles may be a weight ratio of 5:95 to 95:5.

The metal may be Ag, Au, Sn, Zn, Al, Mg, Ge, Cu, In, Ni, Bi, Pt, Pd, or a combination thereof.

The amorphous carbon may be carbon black, acetylene black, denka black, ketjen black, furnace black, activated carbon, or a combination thereof.

The all-solid-state metal battery may further include a positive electrode and a solid electrolyte layer between the negative electrode and the positive electrode.

The solid electrolyte may be a sulfide-based solid electrolyte.

### Advantageous Effects

The all-solid-state metal battery according to an embodiment may exhibit excellent electrochemical characteristics.

### ADVANTAGEOUS EFFECTS

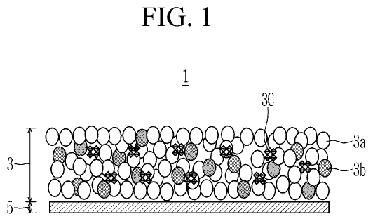

FIG. 1 is a schematic view schematically showing a negative electrode of an all-solid-state metal battery according to an embodiment.

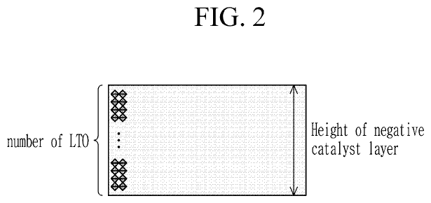

FIG. 2 is a schematic view showing the arrangement of lithium titanium compound particles in a negative electrode of an all-solid-state metal battery according to an embodiment.

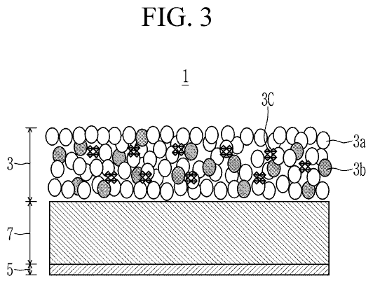

FIG. 3 is a schematic diagram schematically showing a negative electrode of an all-solid-state metal battery according to another embodiment.

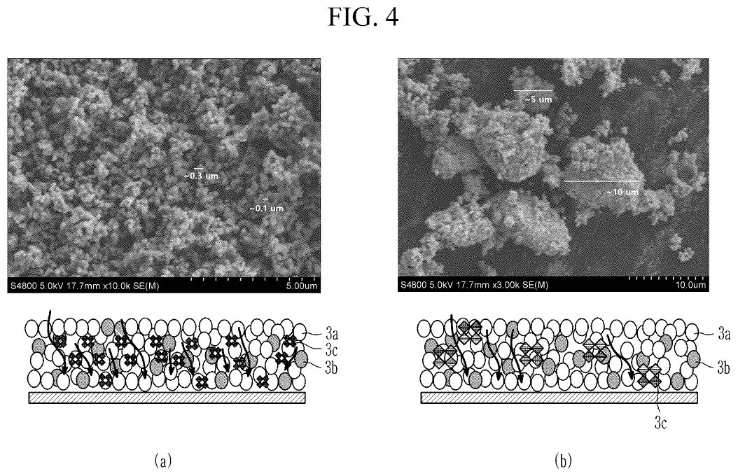

FIG. 4 is a FE-SEM photograph of the cross-section of the negative electrodes of the all-solid-state metal battery cells of Example 2 and Reference Example 4.

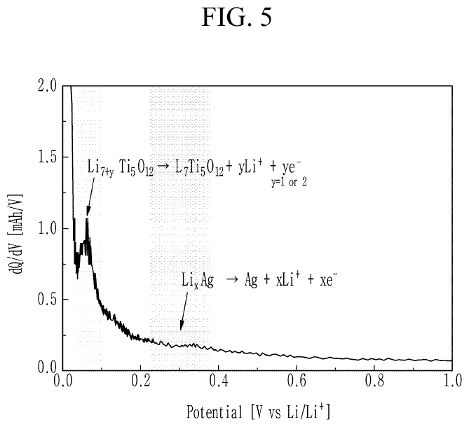

FIG. 5 is a graph showing the dQ/dV of an all-solid-state metal battery cell manufactured according to Example 2.

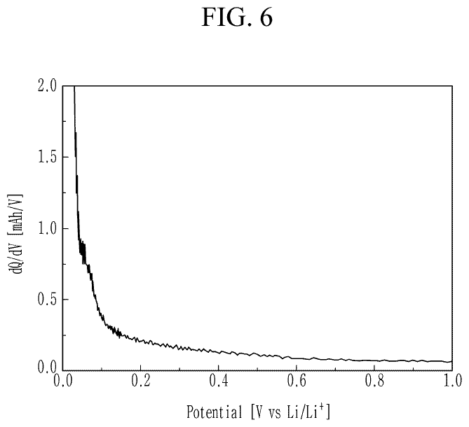

FIG. 6 is a graph showing the dQ/dV of an all-solid-state metal battery cell manufactured according to Comparative Example 2.

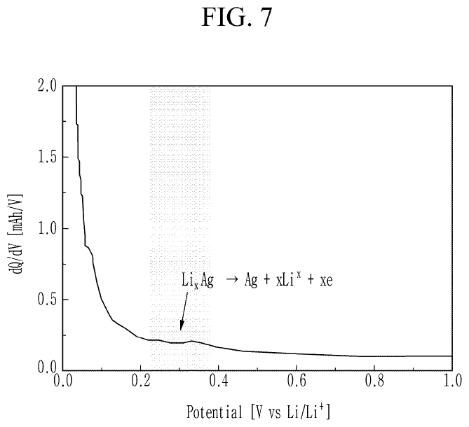

FIG. 7 is a graph showing the dQ/dV of an all-solid-state metal battery cell manufactured according to Comparative Example 3.

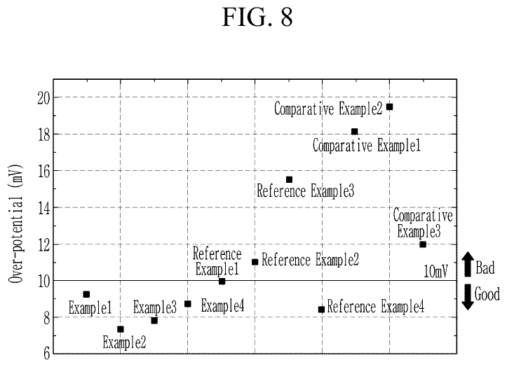

FIG. 8 is a graph showing the overvoltage results of all-solid-state metal battery cells manufactured according to Examples 1 to 4, Comparative Examples 1 and 2, and Reference Examples 1 to 4.

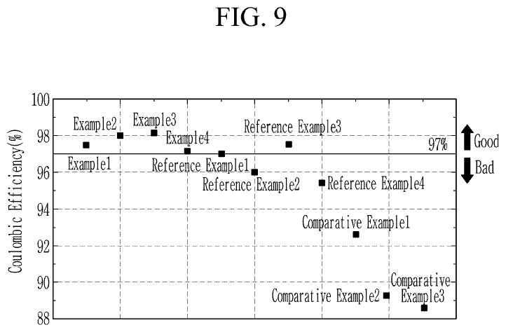

FIG. 9 is a graph showing the charge/discharge efficiency of all-solid-state metal battery cells manufactured according to Examples 1 to 4, Comparative Examples 1 and 2, and Reference Examples 1 to 4.

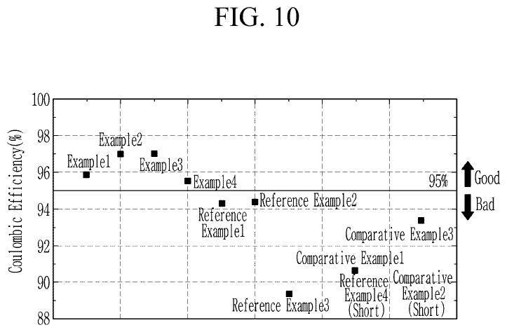

FIG. 10 is a graph showing the power efficiency of all-solid-state metal battery cells manufactured according to Examples 1 to 4, Comparative Examples 1 and 2, and Reference Examples 1 to 4.

### BEST MODE FOR PERFORMING INVENTION

Hereinafter, embodiments of the present invention will be described in detail. However, these embodiments are merely examples, the present invention is not limited thereto, and the present invention is defined by the scope of claims.

The terminology used herein is used to describe embodiments only, and is not intended to limit the present disclosure. Expressions in the singular include a plurality of expressions unless the context clearly dictates otherwise.

As used herein, “combination thereof” means a mixture, a laminate, a composite, a copolymer, an alloy, a blend, a reaction product, and the like of the constituents.

Here, the term “comprise,” “include” or “have” are intended to designate that the performed characteristics, numbers, step, constituted elements, or a combination thereof is present, but it should be understood that the possibility of presence or addition of one or more other characteristics, numbers, steps, constituted element, or a combination do not be precluded in advance.

The drawing shows that the thickness is enlarged in order to clearly show the various layers and regions, and the same reference numerals are given to similar parts throughout the specification. It will be understood that when an element such as a layer, film, region, or substrate is referred to as being “on” another element, it may be directly on the other element or intervening elements may also be present. In contrast, when an element is referred to as being “directly on” another element, there are no intervening elements present.

In addition, “layer” herein includes not only a shape formed on the whole surface when viewed from a plan view, but also a shape formed on a partial surface.

Herein, “or” is not to be construed as an exclusive meaning, for example, “A or B” is construed to include A, B, A+B, and the like.

Unless otherwise defined in this specification, particle diameter or size may be an average particle diameter. This average particle diameter refers to the average particle diameter (D50), which means the diameter of particles with a cumulative volume of 50 volume % in the particle size distribution. The average particle diameter (D50) may be measured by methods well known to those skilled in the art, for example, by measuring with a particle size analyzer, a transmission electron microscope or scanning electron microscope, or a scanning electron microscope. Alternatively, a dynamic light-scattering measurement device is used to perform a data analysis, and the number of particles is counted for each particle size range, and from this, the average particle diameter (D50) value may be easily obtained through a calculation.

An all-solid-state metal battery according to an embodiment includes a negative electrode including a current collector and a negative electrode coating layer located on one surface of the current collector and including a metal, amorphous carbon, and lithium titanium oxide particles. FIG. 1 illustrates a negative electrode according to an embodiment, wherein the negative electrode 1 includes a current collector 5 and a negative electrode coating layer 3, and the negative electrode coating layer 3 includes amorphous carbon 3a, a metal 3b, and lithium titanium oxide particles 3c.

In an embodiment, the negative electrode coating layer refers to a layer that helps lithium ions deintercalated from the positive electrode active material during charging and discharging of an all-solid-state battery to move toward the negative electrode and be precipitated on the surface of a current collector. That is, a lithium deposition layer is formed between the current collector and the negative electrode coating layer due to the precipitation of lithium ions, and the lithium deposition layer acts as a negative electrode active material, and such a negative electrode is generally called a deposition-type negative electrode. The metal and amorphous carbon included in the negative electrode coating layer do not act as a negative electrode active material that directly participate in the charge and discharge reaction. In an embodiment, the lithium titanium oxide particles also do not act as a negative electrode active material directly participating in the charge/discharge reaction. This deposition-type negative electrode means a negative electrode that does not include a negative electrode active material if assembling a battery, but in which the lithium deposition layer acts as a negative electrode active material.

An all-solid-state metal battery including such a negative electrode coating layer is a battery different from an all-solid-state ion battery in that the lithium ions of the positive electrode are overcharged and lithium is precipitated in the range of the N/P ratio, which is the range of the capacity of the negative electrode to the capacity of the positive electrode, of less than 1.

In an embodiment, because the lithium titanium oxide particles have lithiophilic properties they may effectively secure a lithium ion movement path so that lithium ions deintercalated from the positive electrode active material during charge and discharge may move well toward the current collector. Therefore, by including lithium titanium oxide particles in the negative electrode coating layer, the efficiency and power characteristics may be improved.

In an embodiment, the lithium titanium oxide particles may be represented by Chemical Formula 1.

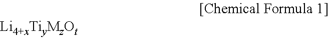

(In Chemical Formula 1, 0<x≤3, 1≤y≤5, 0≤z≤3, 3≤t≤12, and M is an element selected from Mg, La, Tb, Gd, Ce, Pr, Nd, Sm, Ba, Sr, Ca, or a combination thereof)

In an embodiment, the BET surface area of the lithium titanium oxide particles may be 1 m²/g to 20 m²/g, 5 m²/g to 15 m²/g, or 8 m²/g to 15 m²/g. If the BET surface area of the lithium titanium oxide particles is within the above range, there may be an advantage in that it may effectively react with lithium ions and reversibly precipitate lithium.

The particle size of the above lithium titanium oxide particles may be 0.1 μm to 3 μm, 0.5 μm to 3 μm, 1 μm to 3 μm, or 1 μm to 2 μm. If the particle size of the lithium titanium oxide particles is within the above range, the effect of improving efficiency and power characteristics due to the inclusion of the lithium titanium oxide particles may be more effectively obtained.

The thickness of the negative electrode coating layer may be 1 μm to 15 μm, or may be 5 μm to 10 μm. If the thickness of the negative electrode coating layer is within the above range, there may be an advantage in that short circuit may be prevented well while lithium is precipitated during charging, and at the same time, the flux of lithium ions may be induced more uniformly.

As described above, lithium titanium oxide particles may form a lithium ion movement path well in the negative electrode coating layer, and in particular, if 3 to 100 of the lithium titanium oxide particles included in the negative electrode coating layer are located in a vertical direction with respect to one surface of the current collector, the lithium conduction path may be formed more effectively. To explain this in detail, lithium titanium oxide particles are distributed at various locations in the negative electrode coating layer, and among these lithium titanium oxide particles, as shown in FIG. 2, the number of lithium titanium oxide particles located substantially perpendicular to one surface of the current collector, that is, stacked in the direction of the height of the negative electrode coating layer (LTO n number) may be 3 to 100. If the number of lithium titanium oxide particles located in the vertical direction is within the above range, lithium ions may be moved more effectively and sufficiently.

In an embodiment, the particle size of the lithium titanium oxide may be 0.1 μm to 3 μm, and the thickness of the negative electrode coating layer may be 1 μm to 15 μm.

An amount of the lithium titanium oxide particles may be 1 wt % to 30 wt %, 3 wt % to 25 wt %, or 5 wt % to 20 wt % based on 100 wt % of the total of the metal, the amorphous carbon, and the lithium titanium oxide particles. If the amount of lithium titanium oxide particles is within the above range, the effect of including lithium titanium oxide particles may be sufficiently obtained.

The all-solid-state metal battery may have a peak at 0 V to 0.4 V in a differential capacity analysis (dQ/dV) graph. This means that if the results of a charge/discharge experiment of an all-solid-state metal battery, particularly a half-battery including the negative electrode and lithium metal as a counter electrode, are plotted against the voltage (V, horizontal axis) for lithium metal and the charge/discharge capacity differentiated by the voltage (dQ/dV, vertical axis), a peak appears at 0 V to 0.4 V. In an embodiment, the all-solid-state metal battery may have a first peak in the range of 0 V to 0.2 V and a second peak in the range of greater than 0.2 V to 0.4 V in a differential capacity analysis (dQ/dV) graph.

In the results of differential capacity analysis (dQ/dV), the presence of a peak at 0 V to 0.4 V indicates that the negative electrode coating layer includes lithium titanium oxide particles. This is because the peak is a reaction peak caused by the lithium titanium oxide particles.

In an embodiment, the metal included in the negative electrode coating layer may be Ag, Au, Sn, Zn, Al, Mg, Ge, Cu, In, Ni, Bi, Pt, Pd, or a combination thereof. In an embodiment, the metal may be Ag. The metal forms a solid solution with lithium ions, and because the negative electrode coating layer includes this metal, the electrical conductivity of the negative electrode may be further improved, the overvoltage characteristics may be improved, and the efficiency may be improved.

The metal may be a nanoparticle, and a size of the metal nanoparticle may be, for example, an average size of 5 nm to 80 nm, but a nanometer size may be suitable. By using the metal nanoparticles having such nano-size, the battery characteristics (e.g., cycle-life characteristics) of the all-solid-state battery may be further improved. If the metal particle size increases to the micrometer level, the uniformity of the metal particles in the negative electrode coating layer decreases, which is not suitable because the current density in a specific area increases and the cycle-life characteristics may deteriorate.

In the negative electrode coating layer according to an embodiment, an amount of the metal may be 3 wt % to 50 wt %, 3 wt % to 30 wt %, 4 wt % to 25 wt %, 4.5 wt % to 20 wt %, or 4.5 wt % to 15 wt % based on 100 wt % of the negative electrode coating layer.

The amorphous carbon may be carbon black, acetylene black, denka black, ketjen black, furnace black, activated carbon, or a combination thereof. An example of the carbon black is Super P (Timcal). During the all-solid-state battery fabricating process, amorphous carbon may act as a cushion in the pressing process, and lithium may be adsorbed on the surface of the amorphous carbon during charge and discharge, allowing metal and lithium titanium oxide to function appropriately.

Additionally, the amorphous carbon may be a single particle or an aggregate having a secondary particle in which primary particles are aggregated. If the amorphous carbon is a single particle, it may be an amorphous carbon particle having an average particle diameter of less than or equal to 100 nm, for example, a nanosize of 10 nm to 100 nm.

If the amorphous carbon is an aggregate, the particle size of the primary particle may be 20 nm to 100 nm, and the particle size of the secondary particle may be 1 μm to 20 μm.

In an embodiment, the particle size of the primary particles may be greater than or equal to 20 nm, greater than or equal to 30 nm, greater than or equal to 40 nm, greater than or equal to 50 nm, greater than or equal to 60 nm, greater than or equal to 70 nm, greater than or equal to 80 nm, or greater than or equal to 90 nm, and less than or equal to 100 nm, less than or equal to 90 nm, less than or equal to 80 nm, less than or equal to 70 nm, less than or equal to 60 nm, less than or equal to 50 nm, less than or equal to 40 nm, or less than or equal to 30 nm.

In an embodiment, the particle size of the secondary particles may be greater than or equal to 1 μm, greater than or equal to 3 μm, greater than or equal to 5 μm, greater than or equal to 7 μm, greater than or equal to 10 μm, or greater than or equal to 15 μm, and less than or equal to 20 μm, less than or equal to 15 μm, less than or equal to 10 μm, less than or equal to 7 μm, less than or equal to 5 μm, or less than or equal to 3 μm.

The shape of the primary particles may be spherical, elliptical, plate-shaped, and a combination thereof, and in an embodiment, the shape of the primary particles may be spherical, elliptical, and a combination thereof.

Additionally, the carbon-based material may be present in an amount of 60 wt % to 95 wt %, 70 wt % to 95 wt %, 75 wt % to 95 wt %, 80 wt % to 95 wt %, or 85 wt % to 95 wt % based on 100 wt % of the total weight of the negative electrode coating layer.

In an embodiment, the negative electrode coating layer may include a binder, examples of which include a styrene butadiene rubber (SBR), polytetrafluoroethylene, polyvinylidene fluoride, polyethylene, a vinylidenefluoride/hexafluoropropylene copolymer, polyacrylonitrile, polymethylmethacrylate, carboxymethyl cellulose, hydroxypropyl cellulose, diacetyl cellulose, or a combination thereof. The carboxymethyl cellulose may be an alkali metal salt thereof, and the alkali metal may be Na or Li. The binder is not limited to these and any binder used in the relevant technical field may be used.

According to an embodiment, in the negative electrode coating layer, an amount of the binder may be 1 wt % to 20 wt %, 3 wt % to 15 wt %, or 5 wt % to 10 wt % based on 100 wt % of the total negative electrode coating layer. If the binder amount is within the above range, the binder may act as a network between the metal, amorphous carbon and lithium titanium oxide, thereby stably maintaining the shape of the negative electrode.

The negative electrode coating layer may further include an additive such as a filler, or a dispersant. As the filler and dispersant that may be included in the negative electrode coating layer, known materials generally used in all-solid-state batteries may be used.

Another embodiment provides an all-solid-state metal battery including a current collector, a negative electrode coating layer including metal, amorphous carbon, and lithium titanium oxide particles and a lithium deposition layer between the current collector and the negative electrode coating layer. A negative electrode structure according to another embodiment is shown in FIG. 3, and in FIG. 3, the same drawing symbols as in FIG. 1 indicate the same configuration as in FIG. 1. As shown in FIG. 3, a negative electrode according to another embodiment includes a current collector 5, a lithium deposition layer 7, and a negative electrode coating layer 3, and the negative electrode coating layer 3 includes amorphous carbon 3a, a metal 3b, and lithium titanium oxide particles 3c.

In the following description, description of the same configuration as the above implementation example is omitted.

At this time, the lithium titanium oxide particles may be represented by the following chemical formula 2 or the following chemical formula 3.

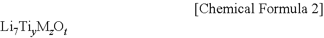

(In Chemical Formula 1, 1≤y≤5, 0≤z≤3, 3≤t≤12, and M is an element selected from Mg, La, Tb, Gd, Ce, Pr, Nd, Sm, Ba, Sr, Ca, or a combination thereof)

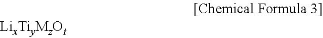

(In Chemical Formula 1 8≤y≤9, 1≤y≤5, 0≤z≤3, 3≤t≤12, M is an element selected from Mg, La, Tb, Gd, Ce, Pr, Nd, Sm, Ba, Sr, Ca, or a combination thereof)

In an embodiment, a mixing ratio of the first compound particles and the second compound particles may be a weight ratio of 5:95 to 95:5, and may be a weight ratio of 30:70 to 70:30.

The lithium deposition layer may act as a lithium reservoir. A thickness of the lithium precipitation layer may be 1 μm to 1000 μm, 1 μm to 500 μm, 1 μm to 200 μm, 1 μm to 150 μm, 1 μm to 100 μm, or 1 μm to 50 μm. If the thickness of the lithium deposition layer is within the above range, it may properly function as a lithium storage layer and may further improve its cycle-life.

The lithium deposition layer may be formed if the all-solid-state battery is charged, lithium ions are deintercalated from the positive electrode active material, pass through the solid electrolyte, and move toward the negative electrode, resulting in lithium precipitation and deposition on the negative electrode current collector.

The charging process may be a formation process performed 1 time to 3 times at 0.05 C to 1 C at about 25° C. to 50° C. Because lithium included in the lithium-containing layer is ionized and moves toward the positive electrode during discharge, the lithium may be used as a negative electrode active material.

Because the lithium deposition layer is located between the current collector and the negative electrode coating layer, the negative electrode coating layer may act as a protective layer of the lithium deposition layer, thereby suppressing the precipitation growth of lithium dendrites. As a result, short circuiting and capacity reduction of the all-solid-state battery may be suppressed, and as a result, the cycle-life of the all-solid-state battery may be improved.

The current collector may include, for example, indium (In), copper (Cu), magnesium (Mg), stainless steel, titanium (Ti), iron (Fe), cobalt (Co), nickel (Ni), zinc (Zn), aluminum (AI), germanium (Ge), lithium (Li), or an alloy thereof, and may be in the form of a foil or sheet. A thickness of the negative electrode current collector may be 1 μm to 20 μm, 5 μm to 15 μm, or 7 μm to 10 μm.

The current collector may include a metal substrate and may further include a thin film formed on the substrate. The thin film may include an element that may form an alloy with lithium, and may be, for example, gold, silver, zinc, tin, indium, silicon, aluminum, bismuth, or a combination thereof, but is not limited thereto, and in the technical field, any element that may form an alloy with lithium may be used. If the current collector further includes the thin film and the lithium deposition layer is formed by precipitating during charging, a more flattened lithium deposition layer may be formed, thereby further improving the cycle-life of the all-solid-state battery.

A thickness of the thin film may be 1 nm to 800 nm, 10 nm to 700 nm, 50 nm to 600 nm, or 100 nm to 500 nm. If the film thickness is within the above range, the cycle-life characteristics may be further improved.

The all-solid-state battery includes the positive electrode and a solid electrolyte layer between the negative electrode and positive electrode.

The solid electrolyte layer may include a solid electrolyte. The solid electrolyte may be an inorganic solid electrolyte such as a sulfide-based solid electrolyte, an oxide-based solid electrolyte, a halide-based solid electrolyte, or a solid polymer electrolyte. In an embodiment, the solid electrolyte may be a sulfide-based solid electrolyte, for example, an argyrodite-type sulfide-based solid electrolyte. The sulfide-based solid electrolyte is suitable because it has superior ionic conductivity compared to other solid electrolytes such as oxide-based solid electrolytes, and may exhibit excellent cycle-life characteristics over a wider operating range.

The sulfide-based solid electrolyte may be Li₂S—P₂S₅, Li₂S—P₂S₅—LiX (wherein X is a halogen element), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (m and n are integers of 0 or more and 12 or less and Z is one of Ge, Zn, or Ga), Li₂S—GeS₂, Li₂S—SiS₂—Li₃PO₄, Li₂S—SiS₂-LiₚMO_{q} (wherein p and q are each 0 or more and 12 or less and M is one of P, Si, Ge, B, Al, Ga, or In), or LiₐM_{b}P_{c}S_{d}Aₑ (wherein a, b, c, d, and e are each 0 or more and 12 or less, M is Ge, Sn, Si, or a combination thereof, and A is one of F, Cl, Br, or I). For example, it may be, for example, Li₇₋ₓPS₆₋ₓFₓ (0≤x≤2), Li₇₋ₓPS₆₋ₓClₓ(0≤x≤2), Li₇₋ₓPS₆₋ₓBrₓ (0≤x≤2), or Li₇₋ₓPS₆₋ₓIₓ (0≤x≤2). In addition, specifically, it may be Li₃PS₄, Li₃PS₄, Li₇P₃S₁₁, Li₇PS₆, Li₆PS₅Cl, Li₆PS₅Cl, Li₆PS₅Br, Li₆PS₅I, Li_{5.8}PS_{4.8}Cl_{1.2}, or Li_{6.2}PS_{5.2}Br_{0.8}.

The sulfide-based solid electrolyte may be obtained by, for example, mixing Li₂S and P₂S₅ in a mole ratio of 50:50 to 90:10 or 50:50 to 80:20. Within the above mixing ratio range, a sulfide-based solid electrolyte having excellent ionic conductivity may be prepared. The ionic conductivity may be further improved by adding SiS₂, GeS₂, B₂S₃, and the like as other components thereto. Mechanical milling or a solution method may be applied as a mixing method. The mechanical milling is to make starting materials into particulates by putting the starting materials, ball mills, and the like in a reactor and fervently stirring them. The solution method may be performed by mixing the starting materials in a solvent to obtain a solid electrolyte as a precipitate. Additionally, additional firing may be performed after mixing. If additional firing is performed, the crystals of the solid electrolyte may become more rigid.

The sulfide-based solid electrolyte may be amorphous or crystalline, or may be a mixture of the two. Of course, a commercially available solid electrolyte may be used as the sulfide-based solid electrolyte. Of course, a commercially available sulfide-based solid electrolyte may also be used as the sulfide-based solid electrolyte.

The oxide-based inorganic solid electrolyte may be, for example, Li₁₊ₓTi₂₋ₓAl(PO₄)₃ (LTAP) (0≤x≤4), Li_{1+x+y}AlₓTi₂₋ₓSi_{y}P_{3-y}O₁₂ (0<x<2, 0≤y<3), BaTiO₃, Pb(Zr,Ti)O₃ (PZT), Pb₁₋ₓLaₓZr_{1-y}Ti_{y}O₃ (PLZT) (0≤x<1, 0≤y<1), Pb(Mg₃Nb_{2/3})O₃—PbTiO₃ (PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, lithium phosphate (Li₃PO₄), lithium titanium phosphate (LiₓTi_{y}(PO₄)₃, 0<x<2, 0<y<3), Li_{1+x-y}(Al, Ga)ₓ(Ti, Ge)₂₋ₓSi_{y}P_{3-y}O₁₂ (0≤x≤1, and 0≤y≤1), lithium lanthanum titanate (LiₓLa_{y}TiO₃, 0<x<2, and 0<y<3), Li₂O, LiAlO₂, Li₂O—Al₂O₃—SiO₂—P₂O₅—TiO₂—GeO₂-based ceramics, Garnet-based ceramics Li₃₊ₓLa₃M₂O₁₂ (M=Te, Nb, or Zr, and x is an integer of 1 to 10), or a mixture thereof.

The halide-based solid electrolyte may include a Li element, an M element (M is a metal other than Li), and an X element (X is a halogen). Examples of X may include F, Cl, Br, and I. In particular, in the halide-based solid electrolyte, at least one of Br and Cl is suitable as the above X. In addition, examples of M may include metal elements such as Sc, Y, B, Al, Ga, and In.

A composition of the halide-based solid electrolyte is not particularly limited, but may be represented by Li₆₋₃ₐMₐBr_{b}Cl_{c} (where M is a metal other than Li, 0<a<2, 0≤b≤6, 0≤c≤6, b+c=6). At this time, a may be 0.75 or more, 1 or 5 more, and a may be 1.5 or less. The b may be 1 or more, and may be 2 or more. Additionally, the c may be 3 or more, and may be 4 or more. Specific examples of the halide-based solid electrolyte may be Li₃YBr₆, Li₃YCl₆, or Li₃YBr₂Cl₄.

The solid polymer electrolyte may include, for example, one or more selected from polyethylene oxide, poly(diallyldimethylammonium) trifluoromethanesulfonylimide (poly(diallyldimethylammonium)TFSI), Cu₃N, Li₃N, LiPON, Li₃PO₄·Li₂S·SiS₂, Li₂S·GeS₂·Ga₂S₃, Li₂O·11Al₂O₃, Na₂O·11Al₂O₃, (Na,Li)₁₊ₓTi₂₋ₓAlₓ(PO₄)₃ (0.1≤x≤0.9), Li₁₊ₓHf₂₋ₓAlₓ(PO₄)₃ (0.1≤x≤0.9), Na₃Zr₂Si₂PO₁₂, Li₃Zr₂Si₂PO₁₂, Na₅ZrP₃O₁₂, Na₅TiP₃O₁₂, Na₃Fe₂P₃O₁₂, Na₄NbP₃O₁₂, Na-silicates, Li_{0.3}La_{0.5}TiO₃, Na₅MSi₄O₁₂ (wherein M is a rare earth element of Nd, Gd, Dy, and the like), Li₅ZrP₃O₁₂, Li₅TiP₃O₁₂, Li₃Fe₂P₃O₁₂, Li₄NbP₃O₁₂, Li₁₊ₓ(M,Al,Ga)ₓ(Ge_{1-y}Ti_{y})₂₋ₓ(PO₄)₃ (x≤0.8, 0≤y≤1.0, M is Nd, Sm, Eu, Gd, Tb, Dy, Ho, Er, Tm, or Yb), Li_{1+x+y}QₓTi₂₋ₓSi_{y}P_{3-y}O₁₂ (0<x≤0.4, 0<y≤0.6, and Q is Al or Ga), Li₆BaLa₂Ta₂O₁₂, Li₇La₃Zr₂O₁₂, Li₅La₃Nb₂O₁₂, Li₅La₃M₂O₁₂ (M is Nb, Ta), and Li₇₊ₓAₓLa₃₋ₓZr₂O₁₂ (0<x<3, A is Zn).

The solid electrolyte may in the form of particles, and an average particle diameter (D50) may be less than or equal to 5.0 μm, for example, 0.1 μm to 5.0 μm, 0.5 μm to 5.0 μm, 0.5 μm to 4.0 μm, 0.5 μm to 3.0 μm, 0.5 μm to 2.0 μm, or 0.5 μm to 1.0 μm.

The solid electrolyte layer may further include a binder. At this time, the binder may be a styrene butadiene rubber, polytetrafluoroethylene, polyvinylidene fluoride, polyethylene, acrylate-based polymer, or a combination thereof, but is not limited thereto, and anything used as a binder in the art may be used. The acrylate-based polymer may be butyl acrylate, polyacrylate, polymethacrylate, or a combination thereof.

The solid electrolyte layer may be formed by adding a solid electrolyte to a binder solution, coating it on a base film, and drying the resultant. The solvent of the binder solution may be isobutyryl isobutyrate, xylene, toluene, benzene, hexane, or a combination thereof. A forming process of the solid electrolyte layer is well known in the art, and thus a detailed description thereof will be omitted.

A thickness of the solid electrolyte layer may be, for example, 10 μm to 150 μm.

The solid electrolyte layer may further include an alkali metal salt, and/or an ionic liquid, and/or a conductive polymer.

The alkali metal salt may be, for example, a lithium salt. An amount of the lithium salt in the solid electrolyte layer may be greater than or equal to 1 M, for example, 1 M to 4 M. In this case, the lithium salt may improve ionic conductivity by improving lithium ion mobility of the solid electrolyte layer.

The lithium salt may include, for example, LiSCN, LiN(CN)₂, Li(CF₃SO₂)₃C, LiC₄F₉SO₃, LiN(SO₂CF₂CF₃)₂, LiCl, LiF, LiBr, LiI, LiB(C₂O₄)₂, LiBF₄, LiBF₃(C₂F₅), lithium bis(oxalato) borate (LiBOB), lithium oxalyldifluoroborate (LIODFB), lithium difluoro(oxalato) borate (LiDFOB), lithium bis(trifluoromethanesulfonyl)imide (LiTFSI, LiN(SO₂CF₃)₂), lithium bis(fluorosulfonyl)imide (LiFSI, LiN(SO₂F)₂), LiCF₃SO₃, LiAsF₆, LiSbF₆, LiClO₄, or a mixture thereof.

In addition, the lithium salt may be an imide-based salt, for example, the imide-based lithium salt may be lithium bis(trifluoromethane sulfonyl)imide (LiTFSI, LiN(SO₂CF₃)₂), and lithium bis(fluorosulfonyl)imide (LiFSI, LiN(SO₂F)₂). The lithium salt may maintain or improve ionic conductivity by appropriately maintaining chemical reactivity with the ionic liquid.

The ionic liquid has a melting point below room temperature, so it is in a liquid state at room temperature and refers to a salt or room temperature molten salt composed of ions alone.

The ionic liquid may be a compound including a) at least one cation selected from ammonium-based, pyrrolidinium-based, pyridinium-based, pyrimidinium-based, imidazolium-based, piperidinium-based, pyrazolium-based, oxazolium-based, pyridazinium-based, phosphonium-based, sulfonium-based, triazolium-based, and a mixture thereof, and b) at least one anion selected from BF₄⁻, PF₆⁻, AsF₆⁻, SbF₆⁻, AlCl₄⁻, HSO₄⁻, ClO₄⁻, CH₃SO₃⁻, CF₃CO₂⁻, Cl—, Br⁻, I⁻, BF₄⁻, SO₄⁻, CF₃SO₃⁻, (FSO₂)₂N⁻, (C₂F₅SO₂)₂N⁻, (C₂F₅SO₂)(CF₃SO₂)N⁻, and (CF₃SO₂)₂N—.

The ionic liquid may be, for example, one or more selected from N-methyl-N-propylpyrrolidinium bis(trifluoromethanesulfonyl)imide N-butyl-N-methylpyrrolidium bis(3-trifluoromethylsulfonyl) imide, 1-butyl-3-methylimidazolium bis(trifluoromethylsulfonyl)amide, and 1-ethyl-3-methylimidazolium bis(trifluoromethylsulfonyl)amide.

The positive electrode includes a current collector and a positive electrode active material layer on one surface of the current collector.

The positive electrode active material layer may include a positive electrode active material. The positive electrode active material may be a positive electrode active material capable of reversibly intercalating and deintercalating lithium ions and for example, the positive electrode active material may be, for example, at least one of a composite oxide of lithium and a metal selected from cobalt, manganese, nickel, and a combination thereof. Examples of the positive electrode active material may include LiₐA_{1-b}B¹_{b}D¹₂ (0.90≤a≤1.8, 0≤b≤0.5); LiₐE_{1-b}B¹_{b}O_{2-c}D¹_{c} (0.90≤a≤1.8, 0≤b≤0.5, 0≤c≤0.5); LiₐE_{2-b}B¹_{b}O_{4-c}D¹_{c} (0.90≤a≤1.8, 0≤b≤0.5, 0≤c≤05); LiₐNi_{1-b-c}Co_{b}B¹_{c}D¹ₐ (0.90≤a≤1.8, 0≤b≤0.5, 0≤c≤0.5, 0<α≤2); LiₐNi_{1-b-c}Co_{b}B¹_{c}O_{2-α}F¹_{α} (0.90≤a≤1.8, 0≤b≤0.5, 0≤c≤0.5, 0<α<2); LiₐNi_{1-b-c}Co_{b}B¹_{c}O_{2-α}F¹₂ (0.90≤a≤1.8, 0≤b≤0.5, 0≤c≤0.5, 0<α<2); LiₐNi_{1-b-c}Mn_{b}B¹_{c}D¹_{α} (0.90≤a≤1.8, 0≤b≤0.5, 0≤c≤0.5, 0<α≤2); LiₐNi_{1-b-c}Mn_{b}B¹_{c}O_{2-α}F¹_{α} (0.90≤a≤1.8, 0≤b≤0.5, 0≤c≤0.5, 0<α<2); LiₐNi_{1-b-c}Mn_{b}B¹_{c}O_{2-α}F¹₂ (0.90≤a≤1.8, 0≤b≤0.5, 0≤c≤0.5, 0<α<2); LiₐNi_{b}E_{c}G_{d}O₂ (0.90≤a≤1.8, 0≤b≤0.9, 0≤c≤0.5, 0.001≤d≤0.1); LiₐNi_{b}Co_{c}L¹_{d}GeO₂ (0.90≤a≤1.8, 0≤b≤0.9, 0≤c≤0.5, 0<d≤0.5, 0.001≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMnG_{b}O₂ (0.90≤a≤1.8, 0.001≤b≤0.1); LiₐMn₂G_{b}O₄ (0.90≤a≤1.8, 0.001≤b≤0.1); QO₂; QS₂; LiQS₂; V₂O₅; LiV₂O₅; LiI¹O₂; LiNiVO₄; Li_{(3-f)}J₂(PO₄)₃ (0≤f≤2); Li_{(3-f)}Fe₂(PO₄)₃ (0≤f≤2); or LiFePO₄.

In the above chemical formulas, A is Ni, Co, Mn, or a combination thereof; B¹ is Al, Ni, Co, Mn, Cr, Fe, Mg, Sr, V, a rare earth element, or a combination thereof; D¹ is O, F, S, P, or a combination thereof; E is Co, Mn, or a combination thereof; F¹ is F, S, P, or a combination thereof; G is Al, Cr, Mn, Fe, Mg, La, Ce, Sr, V, or a combination thereof; Q is Ti, Mo, Mn, or a combination thereof; I¹ is Cr, V, Fe, Sc, Y, or a combination thereof; J is V, Cr, Mn, Co, Ni, Cu, or a combination thereof; and L¹ is Mn, Al, or a combination thereof.

According to an embodiment, the positive electrode active material may be a ternary lithium transition metal such as LiNiₓCo_{y}Al_{z}O₂ (NCA), LiNiₓCo_{y}Mn_{z}O₂ (NCM) (wherein 0<x<1, 0<y<1, 0<z<1, x+y+z=1).

Also, the compounds may have a coating layer on the surface, or may be mixed with another compound having a coating layer. The coating layer may include at least one coating element compound selected from an oxide of a coating element, a hydroxide of a coating element, an oxyhydroxide of a coating element, an oxycarbonate of a coating element, and a hydroxyl carbonate of a coating element. The compound for the coating layer may be amorphous or crystalline. The coating element included in the coating layer may include Mg, Al, Co, K, Na, Ca, Si, Ti, V, Sn, Ge, Ga, B, As, Zr, or a mixture thereof. The coating layer may be disposed in a method having no adverse influence on properties of a positive electrode active material by using these elements in the compound, and for example, the method may include any coating method such as spray coating, dipping, and the like, but is not illustrated in more detail because it is well-known in the related field.

In addition, as the coating layer, any known coating layer for the positive electrode active material of an all-solid-state battery may be applied, examples of which include Li₂O—ZrO₂ (LZO).

In addition, if the positive electrode active material includes nickel, cobalt and manganese, or nickel, cobalt and aluminum, the capacity density of the all-solid-state battery may be further improved and metal elution from the positive electrode active material in the charged state may be further reduced. Because of this, the long-term reliability and cycle characteristics of the all-solid-state battery may be further improved in a charged state.

Here, examples of the shape of the positive electrode active material include particle shapes such as spheres and ellipsoids-spheres. Additionally, the average particle diameter of the positive electrode active material is not particularly limited, and may be within a range applicable to the positive electrode active material of existing all-solid-state rechargeable batteries. Additionally, the amount of the positive electrode active material in the positive electrode active material layer is not particularly limited, and may be within a range applicable to the positive electrode layer of an existing all-solid-state rechargeable batteries.

The positive electrode active material layer may further include a solid electrolyte. The solid electrolyte included in the positive electrode active material layer may be the aforementioned solid electrolyte, and in this case, it may be the same as or different from the solid electrolyte included in the solid electrolyte layer. The solid electrolyte may be included in an amount of 10 wt % to 30 wt % based on a total weight of the positive electrode active material layer.

The current collector may include, for example, indium (In), copper (Cu), magnesium (Mg), stainless steel, titanium (Ti), iron (Fe), cobalt (Co), nickel (Ni), zinc (Zn), aluminum (Al), germanium (Ge), lithium (Li), or an alloy thereof, and may be in the form of a foil or sheet.

The positive electrode active material layer may further include a binder and/or a conductive material.

The binder may include polyvinyl alcohol, carboxymethyl cellulose, hydroxypropyl cellulose, diacetyl cellulose, polyvinylchloride, carboxylated polyvinylchloride, polyvinyl fluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but is not limited thereto.

The binder may be included in an amount of 0.1 wt % to 5 wt %, or 0.1 wt % to 3 wt %, based on a total weight of each component of the positive electrode for the all-solid-state battery, or based on a total weight of the positive electrode active material layer. Within the above amount range, the binder may sufficiently exhibit adhesive ability without deteriorating battery performance.

The conductive material is used to impart conductivity to the electrode, and any material that does not cause chemical change and conducts electrons may be used in the battery, and examples thereof may include a carbon-based material such as natural graphite, artificial graphite, carbon black, acetylene black, ketjen black, a carbon fiber, a carbon nanotube, and the like, a metal-based material including copper, nickel, aluminum, silver, etc. and in the form of a metal powder or a metal fiber, a conductive polymer such as a polyphenylene derivative, or a mixture thereof.

The conductive material may be included in an amount of 0.1 wt % to 5 wt %, or 0.1 wt % to 3 wt %, based on a total weight of each component of the positive electrode for the all-solid-state battery, or based on a total weight of the positive electrode active material layer. Within the above amount range, the conductive material may improve electrical conductivity without deteriorating battery performance.

A thickness of the positive electrode active material layer may be 90 μm to 200 μm. For example, the thickness of the positive electrode active material layer may be greater than or equal to 90 μm, greater than or equal to 100 μm, greater than or equal to 110 μm, greater than or equal to 120 μm, greater than or equal to 130 μm, greater than or equal to 140 μm, greater than or equal to 150 μm, greater than or equal to 160 μm, greater than or equal to 170 μm, greater than or equal to 180 μm, or greater than or equal to 190 μm, and less than or equal to 200 μm, less than or equal to 190 μm, less than or equal to 180 μm, less than or equal to 170 μm, less than or equal to 160 μm, less than or equal to 150 μm, less than or equal to 140 μm, less than or equal to 130 μm, less than or equal to 120 μm, or less than or equal to 110 μm. As described above, because the thickness of the positive electrode active material layer is thicker than that of the negative electrode active material layer, the capacity of the positive electrode is greater than that of the negative electrode.

The positive electrode may be manufactured by forming a positive electrode active material layer on a positive electrode current collector by dry or wet coating.

In an embodiment, a cushioning material may be additionally included to buffer thickness changes that occur if the all-solid-state battery is charged and discharged. The cushioning material may be present between the negative electrode and the case, and in the case of a battery in which one or more electrode assemblies are stacked, it may be present between different electrode assemblies.

The cushioning material may include a material that has an elastic recovery rate of 50% or more and may have an insulating function, and specifically includes silicone rubber, acrylic rubber, fluorine-based rubber, nylon, synthetic rubber, or a combination thereof. The cushioning material may be present in the form of a polymer sheet.

An all-solid-state battery according to an embodiment may be fabricated by placing a negative electrode, a positive electrode, and a solid electrolyte layer between the negative electrode and the positive electrode, preparing a stack, and pressing the stack.

The pressing process may be performed in the range of 25° C. to 90° C. Additionally, the pressing process may be performed by pressing at a pressure of less than or equal to 550 MPa, for example less than or equal to 500 MPa, for example 1 MPa to 500 MPa. The pressing time may vary depending on temperature and pressure, and may be, for example, less than 30 minutes. The pressing process may be, for example, an isostatic press, a roll press, or a plate press.

### MODE FOR PERFORMING THE INVENTION

Hereinafter, examples of the present invention and comparative examples are described. These examples, however, are not in any sense to be interpreted as limiting the scope of the invention.

### Example 1

### (1) Manufacturing of Negative Electrode

94.1 wt % of carbon black with an average particle diameter (D50) of 30 nm, 4.9 wt % of Ag with an average size of 60 nm, and 1 wt % of Li₄Ti₅O₁₂ with an average particle diameter (D50) of 1.5 μm were mixed.

95 wt % of the mixture, 2 wt % of carboxymethyl cellulose, and 3 wt % of a styrene-butadiene rubber were mixed in water to prepare a negative electrode coating layer slurry.

The negative electrode coating layer slurry was coated on a 10 μm-thick stainless steel foil current collector and then, vacuum-dried at 80° C. to manufacture a negative electrode having a 9 μm-thick negative electrode coating layer.

### (2) Manufacturing of Solid Electrolyte Layer

To an argyrodite-type solid electrolyte of Li₆PS₅Cl, an isobutyryl isobutyrate binder solution (a solid content: 50 wt %) prepared by adding an acrylate-based polymer of butyl acrylate, was added and then, mixed. Here, the solid electrolyte and the binder were mixed in a weight ratio of 98.7:1.3.

The mixing process was performed by using a Thinky mixer. Subsequently, 2 mm zirconia balls were added to the obtained mixture and then, stirred again by using a Thinky mixer to prepare slurry. The slurry was cast on a polytetrafluoroethylene release film and then, dried at room temperature to manufacture a 100 μm-thick solid electrolyte layer.

(3) Fabricating of all-Solid-State Half-Cell

The manufactured negative electrode, solid electrolyte, and lithium metal counter electrode were sequentially stacked, and a pressure of 8 MPa was applied to fabricate an all-solid-state half-cell (torque half-cell).

### Example 2

A negative electrode and an all-solid-state half-cell were fabricated in the same manner as in Example 1 except that the mixture was prepared by mixing 85.2 wt % of carbon black with an average particle diameter (D50) of 35 nm, 4.8 wt % of Ag with an average size of 60 nm, and 10 wt % of Li₄Ti₅O₂ with an average particle diameter (D50) of 1.5 μm.

### Example 3

A negative electrode and an all-solid-state half-cell were fabricated in the same manner as in Example 1 except that the mixture was prepared by mixing 75.5 wt % of carbon black with an average particle diameter (D50) of 30 nm, 4.5 wt % of Ag with an average size of 60 nm, and 20 wt % of Li₄Ti₅O₁₂ with an average particle diameter (D50) of 1.5 μm.

### Example 4

A negative electrode and an all-solid-state half-cell were fabricated in the same manner as in Example 1 except that the mixture was prepared by mixing 66.5 wt % of carbon black with an average particle diameter (D50) of 30 nm, 3.5 wt % of Ag with an average size of 60 nm, and 30 wt % of Li₄Ti₅O₁₂ with an average particle diameter (D50) of 2 μm.

### Reference Example 1

A negative electrode and an all-solid-state half-cell were fabricated in the same manner as in Example 1 except that the mixture was prepared by mixing 94.2 wt % of carbon black with an average particle diameter (D50) of 30 nm, 5 wt % of Ag with an average size of 60 nm, and 0.8 wt % of Li₄Ti₅O₁₂ with an average particle diameter (D50) of 1.5 μm.

### Reference Example 2

A negative electrode and an all-solid-state half-cell were fabricated in the same manner as in Example 1 except that the mixture was prepared by mixing 64.6 wt % of carbon black with an average particle diameter (D50) of 30 nm, 3.4 wt % of Ag with an average size of 60 nm, and 32 wt % of Li₄Ti₅O₁₂ with an average particle diameter (D50) of 1.5 μm.

### Reference Example 3

A negative electrode and an all-solid-state half-cell were fabricated in the same manner as in Example 1 except that the mixture was prepared by mixing 47.5 wt % of carbon black with an average particle diameter (D50) of 35 nm, 2.5 wt % of Ag with an average size of 60 nm, and 50 wt % of Li₄Ti₅O₁₂ with an average particle diameter (D50) of 2 μm.

### Comparative Example 1

A negative electrode and an all-solid-state half-cell were fabricated in the same manner as in Example 1 except that the mixture was prepared by mixing 70 wt % of carbon black with an average particle diameter (D50) of 34 nm, 0 wt % of Ag, and 30 wt % of Li₄Ti₅O₁₂ with an average particle diameter (D50) of 1.5 μm.

### Comparative Example 2

A negative electrode and an all-solid-state half-cell were fabricated in the same manner as in Example 1 except that the mixture was prepared by mixing 100 wt % of carbon black with an average particle diameter (D50) of 30 nm, 0 wt % of Ag, and 0 wt % of Li₄Ti₅O₁₂.

### Comparative Example 3

A negative electrode and an all-solid-state half-cell were fabricated in the same manner as in Example 1 except that the mixture was prepared by mixing 70 wt % of carbon black with an average particle diameter (D50) of 35 nm, 30 wt % of Ag, and 0 wt % of Li₄Ti₅O₁₂.

### Reference Example 4

A negative electrode and an all-solid-state half-cell were fabricated in the same manner as in Example 1 except that the mixture was prepared by mixing 85.5 wt % of carbon black with an average particle diameter (D50) of 40 nm, 4.5 wt % of Ag with an average particle diameter (D50) of 60 nm, and 10 wt % of Li₄Ti₅O₁₂.

### Experimental Example 1) FE-SEM (Field Emission Scanning Electron Microscope) Measurement

A cross-section FE-SEM photograph of the negative electrode of Example 2 is shown in (a) of FIG. 4, and a cross-section FE-SEM photograph of the negative electrode of Reference Example 4 is shown in (b) of FIG. 4.

In addition, lithium paths inferred from the cross-section of each manufactured negative electrodes were shown in the FE-SEM photographs.

If looking at the cross-section of the negative electrode of Example 2, small lithium titanium oxide particles were uniformly distributed, from which uniform lithium ion movement paths were predicted to be formed. On the contrary, looking at the negative electrode cross-section of Reference Example 4, in which too large lithium titanium oxide particles were distributed, nonuniform lithium ion movement paths were predicted to be formed.

### Experimental Example 2) dQ/dV (Differential Capacity) Measurement

The half-cells according to Example 2 and Comparative Exampled 2 and 3 were once charged and discharged at 0.05 C to obtain a voltage to lithium metal (V, a horizontal axis) and a value obtained by differentiating charge/discharge capacity with the voltage (dQ/dV, a vertical axis). The results are respectively shown in FIG. 5 (Example 2), FIG. 6 (Comparative Example 2), and FIG. 7(Comparative Example 3). As shown in FIG. 5, Example 2 using lithium titanium oxide in the negative electrode coating layer exhibited a peak due to the lithium titanium oxide reaction and a peak due to the use of Ag between 0 V to 0.2 V and between greater than 0.2 V to 0.4 V. On the contrary, as shown in FIG. 6, the case of not including lithium titanium oxide and Ag in the negative electrode coating layer exhibited no relevant peaks. In addition, the case of using no lithium titanium oxide in the negative electrode coating layer, as shown in FIG. 7, exhibited a peak due to the use of Ag.

### Experimental Example 3) Overvoltage Evaluation

The all-solid-state half-cells of Examples 1 to 4, Reference Examples 1 to 4, and Comparative Examples 1 to 3 were once charged at 0.05 C. The cells were measured with respect to a voltage which started to drop at OCV (open circuit voltage, about 2.5 V) up to a point where an inflection point occurred at about 0 mV. The measured results are shown in Table 1 and FIG. 8.

### Experimental Example 4) Evaluation of Charge/Discharge Efficiency

The all-solid-state half-cells of Examples 1 to 4, Reference Examples 1 to 4, and Comparative Examples 1 to 3 were once charged and discharged at 0.05 C. A ratio of discharge capacity to charge capacity (1^{st} discharge capacity/1^{st} charge capacity) was calculated and then, shown as efficiency in Table 1 and FIG. 9.

### Experimental Example 5) Power Efficiency Evaluation

The all-solid-state half-cells according to Examples 1 to 4, Reference Examples 1 to 4, and Comparative Examples 1 to 3 were once charged and discharged at 0.1 C. A ratio of discharge capacity to charge capacity (1^{st} discharge capacity/1^{st} charge capacity) was calculated, and the results are shown as power efficiency in Table 1 and FIG. 10.

TABLE 1

| | Overvoltage | Efficiency | Power efficiency |
|---|---|---|---|
| | (mV) | (%) | (%) |
| Example 1 | 9.2 | 97.5 | 95.9 |
| Example 2 | 7.3 | 98.0 | 96.9 |
| Example 3 | 7.8 | 98.1 | 96.9 |
| Example 4 | 8.7 | 97.1 | 95.5 |
| Reference Example 1 | 9.9 | 97.0 | 94.2 |
| Reference Example 2 | 11.0 | 96.0 | 94.4 |
| Reference Example 3 | 15.5 | 97.5 | 89.5 |
| Comparative Example 1 | 18.1 | 92.4 | 90.5 |
| Comparative Example 2 | 19.5 | 89.2 | Short circuit |
| Comparative Example 3 | 12.0 | 88.5 | 93.5 |
| Reference Example 4 | 8.4 | 95.6 | Short circuit |

As shown in Table 1 and FIG. 8, Examples 1 to 4 and Reference Examples 1 and 4 exhibited excellent overvoltage characteristics, but Comparative Examples 1 to 3 and Reference Examples 2 and 3 exhibited deteriorated overvoltage characteristics.

In addition, as shown in Table 1 and FIG. 9, Examples 1 to 4 and Reference Example 3 exhibited excellent efficiency. On the contrary, Reference Examples 1, 2, and 4 and Comparative Examples 1 to 3 exhibited low efficiency.

In addition, as shown in Table 1 and FIG. 10, Examples 1 to 4 exhibited excellent power efficiency. On the contrary, Reference Examples 1 to 3 and Comparative Examples 1 and 3 exhibited low power efficiency. In addition, Comparative Example 2 and Reference Example 4 exhibited short circuits.

While this disclosure has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. An all-solid-state metal battery, comprising
a negative electrode including a current collector and a negative electrode coating layer located on one surface of the current collector and including a metal, amorphous carbon, and lithium titanium oxide particles.

2. An all-solid-state metal battery, comprising
a negative electrode including a current collector, a negative electrode coating layer including a metal, amorphous carbon, and lithium titanium oxide particles and a lithium deposition layer between the current collector and the negative electrode coating layer.

3. The all-solid-state metal battery as claimed in claim 1, wherein the lithium titanium oxide particles are represented by Chemical Formula 1. 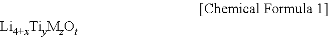
(in Chemical Formula 1, 0<x≤5, 1≤y≤5, 0≤z≤3, 3≤t≤12, and M is an element selected from Mg, La, Tb, Gd, Ce, Pr, Nd, Sm, Ba, Sr, Ca, or a combination thereof)

4. The all-solid-state metal battery as claimed in claim 2, wherein the lithium titanium oxide particles are a mixture of first compound particles represented by Chemical Formula 2 and second compound particles represented by Chemical Formula 3. 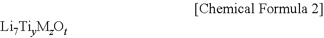
(in Chemical Formula 2, 1≤y≤5, 0≤z≤3, 3≤t≤12, and M is an element selected from Mg, La, Tb, Gd, Ce, Pr, Nd, Sm, Ba, Sr, Ca, or a combination thereof) 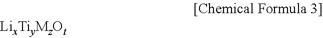
(in Chemical Formula 3, 8≤x≤9, 1≤y≤5, 0≤z≤3, 3≤t≤12, and M is an element selected from Mg, La, Tb, Gd, Ce, Pr, Nd, Sm, Ba, Sr, Ca, or a combination thereof)

5. The all-solid-state metal battery as claimed in claim 1, wherein a particle diameter of the lithium titanium oxide particles is 0.1 μm to 3 μm.

6. The all-solid-state metal battery as claimed in claim 1, wherein a BET specific surface area of the lithium titanium oxide particles is 1 m²/g to 20 m²/g.

7. The all-solid-state metal battery as claimed in claim 1, wherein a thickness of the negative electrode coating layer is 1 μm to 15 μm.

8. The all-solid-state metal battery as claimed in claim 1, wherein 3 to 100 of the lithium titanium oxide particles included in the negative electrode coating layer are located in a vertical direction with respect to one surface of the current collector.

9. The all-solid-state metal battery as claimed in claim 1, wherein an amount of the lithium titanium oxide particles is 1 wt % to 30 wt % based on 100 wt % of the total of the metal, the amorphous carbon, and the lithium titanium oxide particles.

10. (canceled)

11. The all-solid-state metal battery as claimed in claim 1, wherein the all-solid-state metal battery has a peak at 0 V to 0.4 V in a differential capacity analysis (dQ/dV) graph.

12. The all-solid-state metal battery as claimed in claim 4, wherein a mixing ratio of the first compound particles and the second compound particles is a weight ratio of 5:95 to 95:5.

13. The all-solid-state metal battery as claimed in claim 1, wherein the metal is Ag, Au, Sn, Zn, Al, Mg, Ge, Cu, In, Ni, Bi, Pt, Pd, or a combination thereof.

14. The all-solid-state metal battery as claimed in claim 1, wherein the amorphous carbon includes carbon black, acetylene black, denka black, ketjen black, furnace black, activated carbon, or a combination thereof.

15-16. (canceled)

17. The all-solid-state metal battery as claimed in claim 2, wherein a particle diameter of the lithium titanium oxide particles is 0.1 μm to 3 μm.

18. The all-solid-state metal battery as claimed in claim 2, wherein a BET specific surface area of the lithium titanium oxide particles is 1 m²/g to 20 m²/g.

19. The all-solid-state metal battery as claimed in claim 2, wherein a thickness of the negative electrode coating layer is 1 μm to 15 μm.

20. The all-solid-state metal battery as claimed in claim 2, wherein a thickness of the negative electrode coating layer is 1 μm to 15 μm.

21. The all-solid-state metal battery as claimed in claim 2, wherein an amount of the lithium titanium oxide particles is 1 wt % to 30 wt % based on 100 wt % of the total of the metal, the amorphous carbon, and the lithium titanium oxide particles.

22. The all-solid-state metal battery as claimed in claim 2, wherein the all-solid-state metal battery has a peak at 0 V to 0.4 V in a differential capacity analysis (dQ/dV) graph.

23. The all-solid-state metal battery as claimed in claim 2, wherein the metal is Ag, Au, Sn, Zn, Al, Mg, Ge, Cu, In, Ni, Bi, Pt, Pd, or a combination thereof.
